(19) United States
(12) Patent Application Publication
(10) Pub. No.: US 2007/0081748 A1
(43) Pub. Date: Apr. 12, 2007

(54) Tab bearing

(76) Inventor: Don H. Sitter, Grass Lake, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/544,514

(22) Filed: Oct. 6, 2006

Related U.S. Application Data
(60) Provisional application No. 60/724,035, filed on Oct. 6, 2005.

(51) Int. Cl. F16C 9/02

(52) U.S. Cl. 384/294

(57) ABSTRACT

A tab bearing is provided that includes a body having a first outside edge, a second outside edge, an inner surface, and an outer surface. At least one tab projects outwardly from the outer surface at the first outside edge. The tab may only extend partially around the first outside edge such that less than half of the first outside edge is traversed by the tab.

### CROSS REFERENCE TO RELATED APPLICATION

This application claims the benefit of U.S. Provisional Application Ser. No. 60/724,035 filed Oct. 6, 2005 which is hereby incorporated by reference in its entirety.

### TECHNICAL FIELD

The present disclosure relates to a bearing in an internal combustion engine, and in particular to a bearing having at least one tab for engaging with an engine component.

### BACKGROUND

Thrust bearings are typically used to control end play in a crankshaft caused by axial crankshaft thrust loads in internal combustion engines. Control of end play limits the fore and aft movement of the crankshaft in an engine block. However, if an engine is assembled with too much end play of the crankshaft, or if the thrust bearing fails, the crankshaft will engage the engine block and main bearing end caps. This contact by the crankshaft will create premature wear of the engine block and main bearing caps. Furthermore, excessive end play can cause connecting rods to suffer fatigue and fracture, and will loosen wrist pins to cause pistons in the engine to score the surfaces of the engine cylinders.

There are several known types of thrust bearing configurations that are used with crankshafts in conventional internal combustion engines: flange bearings, assembled flange bearings, and conventional straight-shell main bearings. These known thrust bearing configurations are used in conjunction with conventional thrust washers.

Flange bearings are used in an effort to minimize wear in the crankshaft journal. Such a bearing includes an oversized flange on the high side of the tolerance range to compensate for crankshaft thrust surface wear. However, problems occur during the engine block assembly process when the flange bearing exceeds the specified tolerance.

Flange bearings also include flanged surfaces that are formed using the periphery of a grinding wheel. As a result, grinding marks are formed on the surface of the flange that produce a visual swirl or sunburst pattern with scratches, sometimes crisscrossing one another in a cross-hatch pattern. If the grinding marks are not completely removed by polishing, the grinding marks will wipe oil film from the surface of a crankshaft face in the cross-hatch pattern, creating uneven oil distribution. A desirable bearing surface must have very fine polishing marks that go around the thrust bearing surface in a circumferential pattern. Thus, there is a need for an alternative thrust bearing that does not require expensive grinding and polishing operations.

Assembled flange bearings include a modified straight-shell main bearing (axial bearing part) having a radial bearing part component assembled with a side of the straight-shell main bearing. This configuration requires a plurality of parts that need to be assembled, thereby increasing inventory and effort in assembly. Joining the axial bearing part with the radial bearing part is also complicated. It is necessary to obtain access to the inside of the straight-shell bearing in a radial direction during the bending of the retaining tongues that connect the straight-shell bearing and the radial bearing together. Furthermore, the dimensional accuracy of the assembly may be compromised when the retaining tongues of the straight-shell bearing and the radial bearing are bent. As a result, it would be desirable to create a family of functional assemblies that require less inventory and manufacturing effort.

Conventional straight-shell main bearings used in conjunction with conventional thrust washers require that the thrust washers be retained in the engine block by a combination of retention features machined in the engine block, main bearing cap and thrust washer components.

An example of the above described conventional straight-shell main bearing is illustrated in FIG. 1. A prior art, two (2) piece bearing 22 is disposed in a housing bore formed between an engine block 20 and a main bearing cap 34. A main bearing cap thrust washer 24 and an engine block thrust washer 30 are retained in corresponding thrust washer recesses 40 formed on a face of main bearing cap 34 and engine block 20, respectively. Main bearing cap thrust washer 24 includes a main bearing cap retaining feature 38. A main bearing cap washer recess 26 that is disposed on main bearing cap 34 engages main bearing cap retaining feature 38. Engine block thrust washer 30 includes an engine block retaining feature 36. An engine lock washer recess 28 that is disposed on engine block 20 engages engine block retaining feature 36.

However, as may be appreciated, because the retention features of the thrust washers need to engage corresponding features formed in the main bearing cap and engine block, thereby requiring additional machining steps in various components. It would be desirable instead to create a straight-shell bearing that will retain the thrust washer element without the need to machine retention features in the engine block and main bearing cap.

### BRIEF SUMMARY

A tab bearing is disclosed that includes a body having a first outside edge, a second outside edge, an inner surface, and an outer surface. The first outside edge defines a proximal end and the second outside edge defines a distal end. At least one tab is included, which projects outwardly from the first outside edge. The tab may extend only partially around the first outside edge so that less than half of the first outside edge is covered by the tab.

### BRIEF DESCRIPTION OF THE DRAWINGS

Other features and advantages of the tab bearing will become apparent to those skilled in the art from the following detailed description of embodiments thereof, when read in light of the accompanying drawings, in which:

FIG. 1 is an exploded elevational perspective view of a prior art straight-shell main bearing assembly and thrust washers;

FIG. 2 is an elevational perspective view of an engine block with one embodiment of a tab bearing assembly disposed therein;

FIG. 2A is an enlarged, exploded perspective view of the tab bearing assembly of FIG. 2;

FIG. 2B is an enlarged, exploded perspective view similar to FIG. 2A, further illustrating thrust washers;

FIG. 3 is an enlarged, exploded perspective view of a piston assembly and a portion of a crankshaft to which the tab bearing assembly of FIG. 2 is assembled;

FIG. 4 is an elevational front view of the tab bearing assembly of FIG. 2 in a final assembled position disposed around a bore housing of the engine block;

FIG. 5 is an enlarged perspective view of the tab bearing assembly of FIG. 2 showing a lower insert bearing in the bore housing of an engine block;

FIG. 6 is an elevational front view of a lower insert bearing of a second embodiment of a tab bearing assembly;

FIG. 7 is an elevational perspective view of a lower insert bearing of a third embodiment of a tab bearing assembly;

FIG. 8 is a front elevational view of an assembled tab bearing assembly of FIG. 7;

FIG. 9 is an elevational perspective view of a lower insert bearing of a fourth embodiment of a tab bearing assembly;

FIG. 10 is an elevational perspective view of a lower insert bearing of a fifth embodiment of a tab bearing assembly;

FIG. 11 is a front elevational view of an assembled tab bearing assembly of FIG. 10;

FIG. 12 is an elevational perspective view of a lower insert bearing of a seventh embodiment of a tab bearing assembly;

FIG. 13 is a front elevational view of an assembled tab bearing assembly of FIG. 12; and

FIG. 14 is an elevational perspective view of an eighth embodiment of a tab bearing assembly.

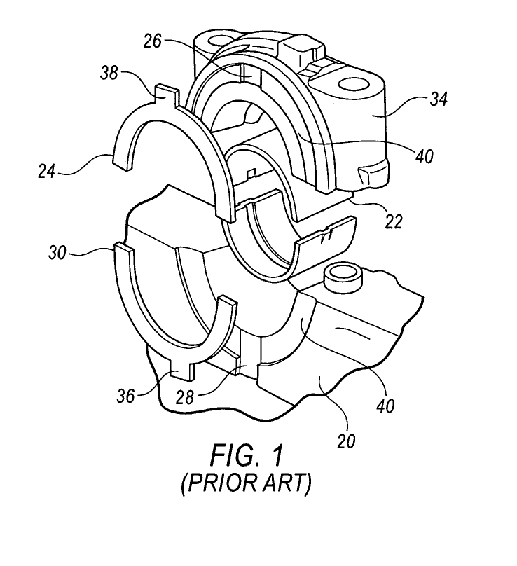

### DETAILED DESCRIPTION

Illustrative embodiments are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints that will vary from one implementation to another. Moreover, it will be appreciated that such a development effort might be complex and time-consuming, but would nevertheless be a routine undertaking for those of ordinary skill in the art having the benefit of this disclosure.

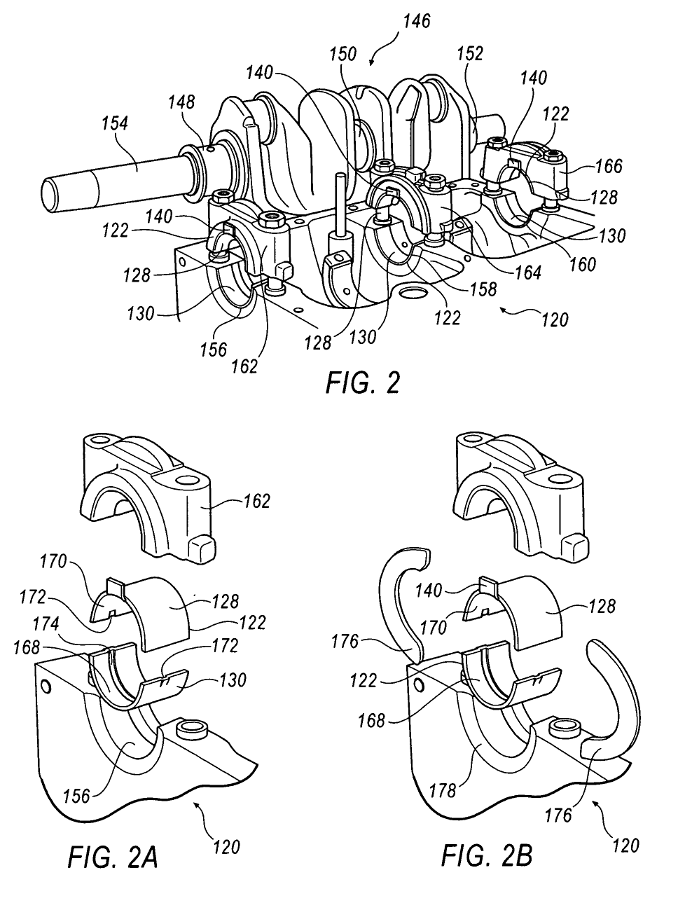

Turning now to the drawings, and in particular to FIGS. 2-5, a first embodiment of a tab bearing assembly 122 is disclosed. In the embodiment shown in FIG. 2, tab bearing assemblies 122 are shown in an engine block housing 120. Tab bearing assemblies 122 comprise an otherwise straight shell main bearing that includes at least one tab.

Tab bearing assemblies 122, as best seen in FIGS. 2A and 2B, each includes an upper insert bearing 128 and a lower insert bearing 130. Upper insert bearing 128 includes at least a first tab 140. It is understood that first tab 140 may be placed on a lower insert bearing 130, as well.

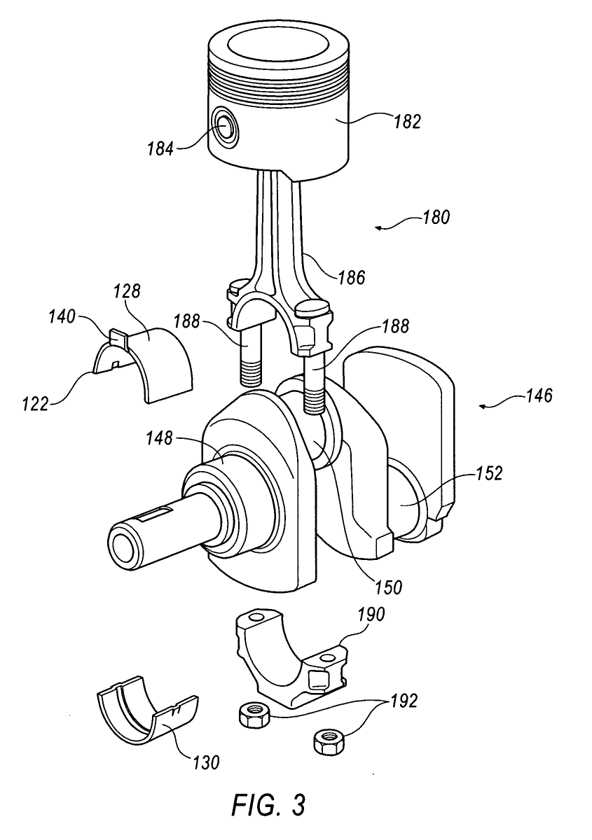

Referring to FIGS. 2 and 3, a crankshaft assembly 146 includes a main journal 148, a first crankpin 150 and a second crankpin 152. First crankpin 150 may be disposed within one of tab bearing assemblies 122 that is positioned between a second housing bore 158 and a second main bearing cap 164. Second crankpin 152 may be disposed within another tab bearing assembly 122, which is positioned between a third housing bore 160 and a third main bearing cap 166.

FIG. 2A illustrates an exploded view of tab bearing assembly 122. As discussed above, tab bearing assembly 122 includes a lower insert bearing 130, which is placed within first housing bore 156, and first upper insert bearing 128, which is placed within a first main bearing cap 162. Tab bearing assembly 122 may include a lower inner periphery 168 and an upper inner periphery 170 that cooperate to act as a journal. Two locating lugs 172 are provided on lower insert bearing 130 and upper insert bearing 128. Locating lugs 172 are provided to prevent rotation or sideways shifting of lower insert bearing 130 and upper insert bearing 128 in first bore housing 156. Locating lugs 172 fit into a slot (not shown) in first housing bore 156.

Tab bearing assembly 122 may be arranged to receive main journal 148. A fluid, for example an oil film (not shown), may be disposed between tab bearing 122 and main journal bearing 148. Both lower inner periphery 168 and upper inner periphery 170 may include an oil bearing groove 174. The oil film between lower inner periphery 168 and upper inner periphery 170 and main journal 148 may provide low-friction support of main journal 148 as it rotates within the lower inner periphery 168 and upper inner periphery 170. It will be understood by one of skill in the art having the benefit of this disclosure, however, that the oil film may be replaced by any other convenient fluid including, but not limited to, water, gas, oil, hydraulic fluid, or the like.

FIG. 2B illustrates tab bearing assembly 122 having thrust washers 176 disposed proximate a front side thereof. More specifically, two (2) half thrust washers 176 are mounted on surfaces radially spaced a predetermined distance from the lower inner periphery 168 and upper inner periphery 170 of tab bearing assembly 122. Thrust washers 176 may be considered as having a large cross-sectional area relative to lower inner periphery 168 and upper inner periphery 170. The thrust washers 176 may have a simple circular perimeter or may have a complex geometry including locking tabs (not shown).

Tab bearing assembly 122 retains thrust washers 176 in place within engine block 120. More specifically, first tab 140, which extends radially outwardly from an edge of upper insert bearing 128, retains a portion of thrust washers 176. Thus, thrust washers 176 are prevented from rotating within thrust washer recesses 178. First tab 140 eliminates the need for any further machining of engine block 120 to retain thrust washers 176.

Referring now to FIG. 3, tab bearing assembly 122 of FIG. 2 is shown with a piston assembly 180 and a different crankshaft assembly 146′. Piston assembly 180 includes a piston 182, a pin 184, a connecting rod 186, a pair of bolts 188, a connecting rod cap 190 and a pair of nuts 192. Connecting rod 186 is assembled with connecting rod cap 190, which forms a first end (not shown) of connecting rod 186 that receives first crankpin 150 of crankshaft assembly 146. Upper insert bearing 128 and lower insert bearing 130 are assembled to receive main journal 148.

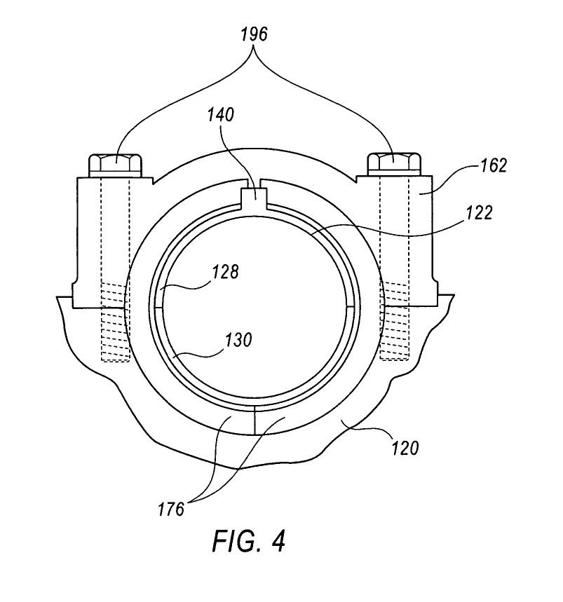

FIG. 4 is a detailed partially cross-sectioned front view of tab bearing assembly 122 of FIG. 2 in a final position disposed around bore housing 156 of engine block 120. First main bearing cap 162 is assembled onto engine block 120, with a pair of bolts 196 securing first main bearing cap 162 in place. First tab 140 retains a portion of thrust washers 176 within thrust washer recess 178 (not shown in FIG. 4), and prevents thrust washers 176 from rotating.

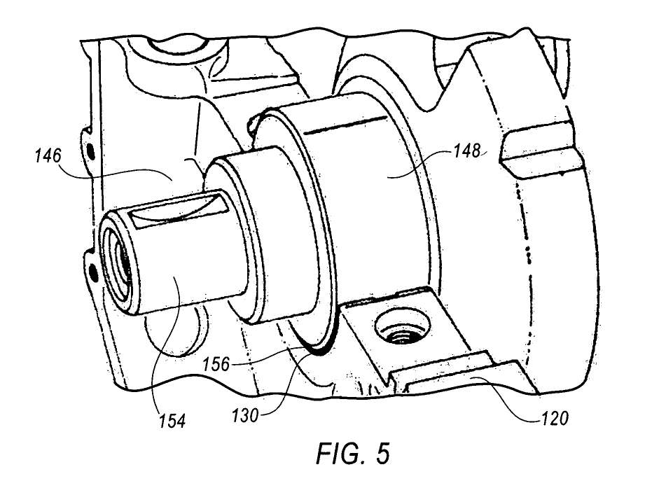

FIG. 5 is a detailed perspective view of tab bearing assembly 122 of FIG. 2, showing lower insert bearing 130 in first bore housing 156 of engine block 120 before main bearing cap 162 and upper insert bearing 128 are installed. Lower insert bearing 130 receives main journal 148.

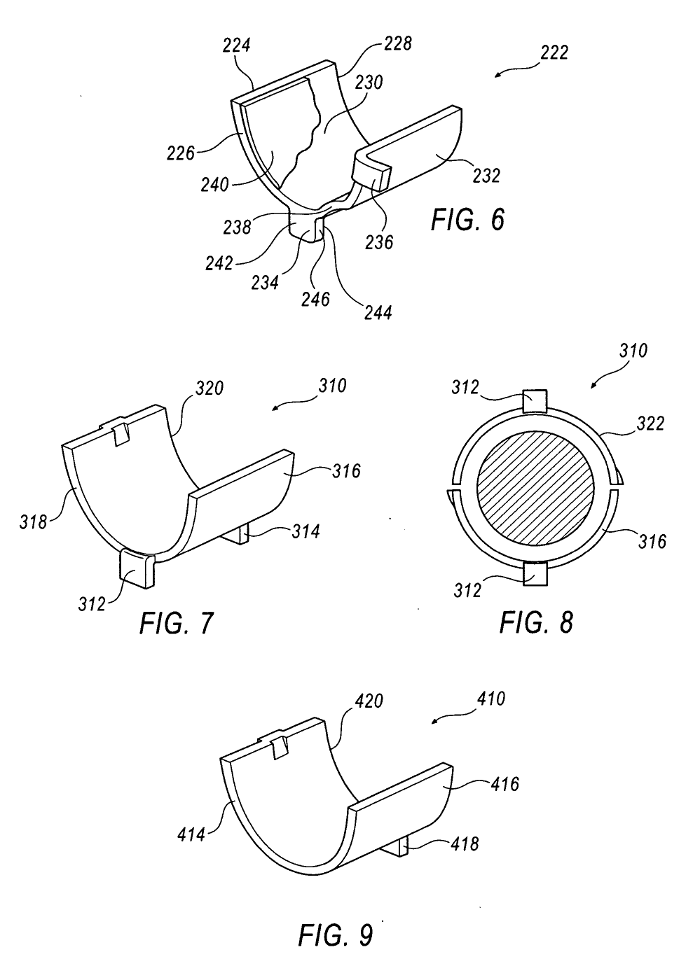

FIG. 6 illustrates a portion of another embodiment of a tab bearing assembly 222 similar to the embodiment shown in FIGS. 2-5. Tab bearing assembly 222 includes a lower insert bearing 224 having a first circumferential edge 226, a second circumferential edge 228, an inner surface 230, and an outer surface 232. First circumferential edge 226 defines a proximal end of lower insert bearing 224 and second circumferential edge 228 defines a distal end of lower insert bearing 224. In addition, a first tab 234 is borne on and projects outwardly from first circumferential edge 226 and outwardly from outer surface 232. First tab 234 may be selectively positioned anywhere along first circumferential edge 226. In addition, an optional second tab 236 may also be borne on first circumferential edge 226 and projecting outwardly from outer surface 232. First tab 234 and second tab 236 may be stamped approximately ninety degrees from outer surface 232 or may be welded at approximately ninety degrees from outer surface 232. Tab bearing 122 may be generally cylindrical in shape, with a generally circular circumferential edge.

In one embodiment, first tab 234 and second tab 236 may be located at generally opposite sides of first circumferential edge 226, or anywhere along first circumferential edge 226. Lower insert bearing 224 may also include an inner surface having a lining or an overlay 240, shown in FIG. 6 in partial cross section. In another embodiment, either or both first tab 234 and second tab 236 have a width between about 0.2 inches and about 1.0 inch.

As mentioned above, tab bearing assembly 222 includes first tab 234, which may be integral therewith. First tab 234 may be formed as an integral part of lower insert bearing 224, or, alternatively, it may be joined to lower insert bearing 224 by welding. First tab 234 generally serves as a flange that traverses less than half of first circumferential edge 226 so that more than half of first circumferential edge 226 will have no flange. Moreover, first tab 234 includes a first surface 242, a second surface 244, and an edge surface 246. First surface 242 defines a proximal end of lower insert bearing 224 and second surface 244 defines a distal end of lower insert bearing 224. Edge surface 246 projects outwardly from outer surface 232. In the embodiment shown, tab bearing assembly 222 is a lower insert bearing 224. However, it is understood that first tab 234 and second tab 236 may be placed on an upper insert bearing as well.

In FIGS. 7 and 8, a third embodiment of tab bearing 310 for a tab bearing assembly is shown having a pair of tabs, namely a first tab 312 and a second tab 314, disposed on a lower insert bearing 316. First tab 312 and second tab 314 may be located anywhere along a circumferential edge of tab bearing 310, wherein first tab 312 extends outwardly from a first circumferential edge 318 to a predetermined distance and second tab 314 is extends outwardly from a second circumferential edge 320 to a predetermined distance. In one specific embodiment, first tab 312 is disposed at approximately the mid-chord point of first circumferential edge 318, and second tab 314 is disposed at the approximately the mid-chord point of second circumferential edge 320, so that first tab 312 and second tab 314 are generally aligned with each other. In the embodiment shown in FIGS. 7, tab bearing 310 is a lower insert bearing. However, it is understood that first tab 312 and second tab 314 may also placed on an upper insert bearing 322, as seen in FIG. 8 as well, or both the upper insert bearing 322 and lower insert bearing 316.

Tab bearing assembly 310 is particularly suited for receiving a crankpin, such as first crankpin 150 or second crankpin 152. However, tab bearing assembly 310 may also be used in other suitable applications.

In yet another alternative embodiment, a tab bearing 410, as shown in FIG. 9, is a lower insert bearing 416 that includes only one tab 418 disposed at approximately the mid-chord point of a second circumferential edge 420 of tab bearing 410. Tab 418 extends outwardly from second circumferential edge 420 through a predetermined distance, while first circumferential edge 414 does not include a tab. Similar to the embodiment depicted in FIGS. 7 and 8, tab 418 extends outwardly from second circumferential edge 420 to a predetermined distance. In the embodiment shown in FIG. 9, tab bearing 410 is a lower insert bearing. However, it is understood that tab 418 may be placed on an upper insert bearing as well, or both the upper insert bearing and lower insert bearing 416.

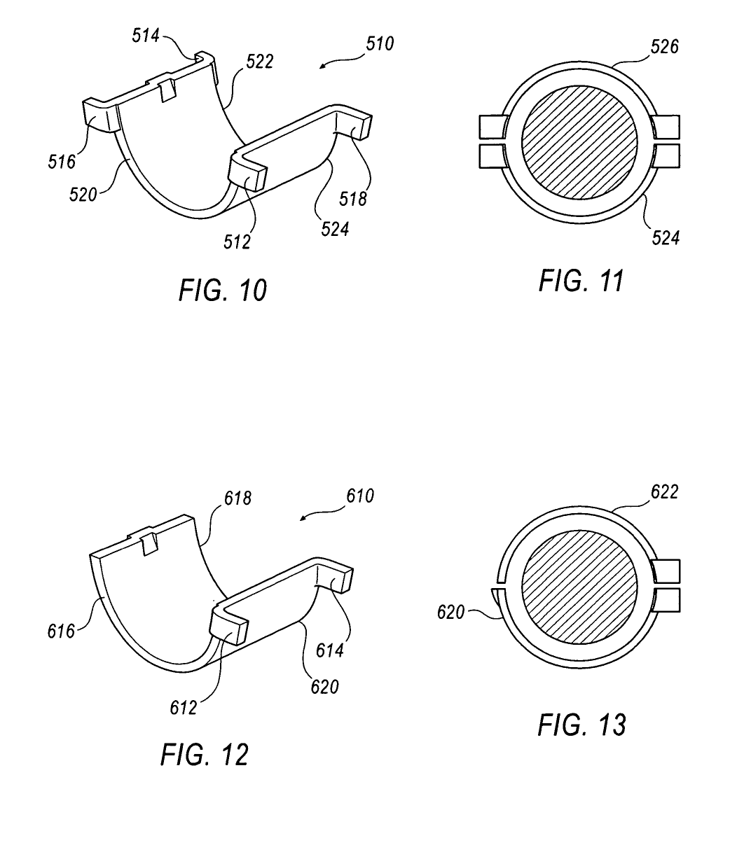

A further embodiment of a tab bearing assembly 510 is shown in FIGS. 10 and 11. Referring to FIG. 10, tab bearing 510 is shown as a lower insert bearing 524 that includes four tabs. In this embodiment, a first tab 512 and a second tab 516 are located on a first circumferential edge 520 of lower insert bearing 524. First tab 512 and second tab 516 may be located at generally opposite sides of first circumferential edge 520 or anywhere along first circumferential edge 520. A second circumferential edge 522 includes a third tab 514 and a fourth tab 518. Similarly to first circumferential edge 520, third tab 514 and fourth tab 518 may be located at generally opposing sides of second circumferential edge 522 or anywhere along second circumferential edge 522. In the embodiment shown in FIGS. 10 and 11, first tab 512 and fourth tab 518 are generally aligned with each other, and second tab 516 and third tab 514 are generally aligned with each other. While tab bearing 510 is a lower insert bearing 524, it is understood that tabs 512, 516, 514, and 518 may be placed on an upper insert bearing 526 as well, or both upper insert bearing 526 and the lower insert bearing 524, as illustrated in FIG. 11.

In a still further embodiment of a tab bearing assembly 610, as shown in FIGS. 12 and 13, includes a lower insert bearing 620 with a first tab 612 and a second tab 614. First tab 612 and second tab 614 are located on opposing circumferential edges, with first tab 612 located on a first circumferential edge 616 and second tab 614 located on a second circumferential edge 618. In this embodiment, first tab 612 is disposed so that it is generally aligned with second tab 614 located on second circumferential edge 618. However, it is understood that first tab 612 may be disposed anywhere on first circumferential edge 616 so long as second tab 614 is generally aligned with first tab 612. In the embodiment shown in FIGS. 12 and 13, tab bearing 610 is a lower insert bearing. However, it is understood that tabs 612 and 614 may be placed on an upper insert bearing 622 as well, or both upper insert bearing 622 and the lower insert bearing 620, as illustrated in FIG. 13.

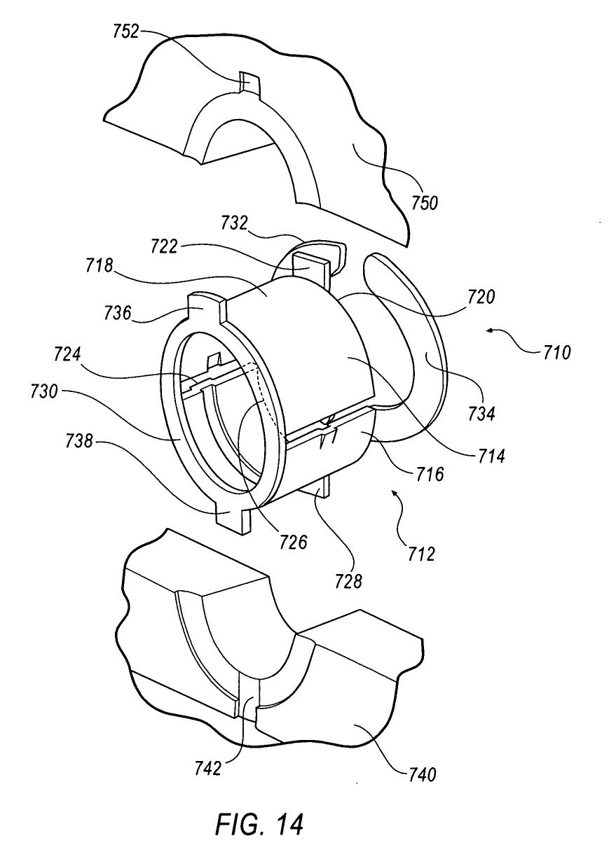

In yet another alternative embodiment, an upper tab bearing 710 and a lower tab bearing 712 are shown in FIG. 14 as an upper insert bearing 714 and a lower insert bearing 716, respectfully. Upper insert bearing 714 includes a first circumferential edge 718 and a second circumferential edge 720, with an upper tab 722 located on second circumferential edge 720. Upper tab 722 retains a first half thrust washer 732 and a second half thrust washer 734 within the thrust washer recess (not shown) of the engine block 740. Additionally, lower insert bearing 716 includes a first circumferential edge 724 and a second circumferential edge 726, with a lower tab 728 located on second circumferential edge 726. Lower tab 728 retains first thrust washer 732 and second thrust washer 734 within the lower thrust washer recess (not shown) of the engine block 740. A full round thrust washer 730 is placed facing first circumferential edge 718 of upper insert bearing 714 and first circumferential edge 724 of lower insert bearing 716. Full round thrust washer 730 is retained in place by an engine block machined recess 742 in engine block 740 and a main bearing cap machined recess 752 in main bearing cap 750. Engine block machined recess 742 engages engine block retaining feature 738, and main bearing cap machined recess 752 engages with main bearing cap retaining feature 736. Full round thrust washer 730 may also be retained in place by only by either engine block machined recess 742 or main bearing cap machined recess 752. It should be noted that tab bearing 410 as depicted in FIG. 9 may be utilized for upper tab bearing 710 and lower tab bearing 712.

A method of manufacturing any of tab bearings 122, 124, 126, 222, 310, 410, 510, 610, 710 or 712 is described as follows. Referring specifically to FIG. 6, it will be noted that first tab 234 projects outwardly from first circumferential edge 226 and outwardly from outer surface 232 at approximately a ninety-degree angle. First tab 234 and second tab 238 may be formed as an integral portion of the lower insert bearing 240, where both first tab 234 and second tab 238 may be formed as part of a blank that will eventually be formed into tab bearing 222.

Alternatively, first tab 234 may be joined to tab bearing 222 at a later step in the manufacturing process by welding, as by conventional arc welding, laser welding and radio frequency welding. First tab 234 is preferably welded to tab bearing 222 after it has been formed into its final curved shape.

It should be noted that while FIG. 14 illustrates generally circular tab bearings 710 and 712, it would be appreciated that a tab bearing that is not generally circular may be used to construct any of tab bearings 122, 124, 126, 222, 310, 410, 510, 610, 710 and 712. Elliptical or irregular configurations, lobes, pressure dam configurations, and other shapes may also be used in a tab bearing adapted to accommodate proper clearances. Proper clearances are extremely important to bearing longevity and oil pressure. Tab bearings generally require a fluid film of at least 0.0001 inch (0.0025 mm) thick between the inner surface and a shaft to prevent metal-to-metal contact. This requires assembly clearances large enough that fluid can flow into the gap between the tab bearing and the shaft to form a fluid wedge to support the crankshaft. The clearance must also be sufficient to allow a fluid flow rate that will cool the tab bearings. But the clearance must not be too great; otherwise, the fluid will escape before it can form a fluid film.

Any or all of tab bearings 122, 124, 126, 222, 310, 410, 510, 610, 710 and 712 may include a bearing housing constructed of steel, babbitt, lead, cadmium, silver, aluminum, aluminum alloy, bimetal or trimetal copper/lead or the like. Bearing materials need to have good corrosion resistance as well as the ability to carry the loads generated by combustion. Aluminum or aluminum alloy bearings tend to flush out debris rather than hold it. Aluminum alloys may also contain silicone, which helps to resist seizure and actually polishes the crankshaft. Aluminum alloys have greater temperature resistance than copper/lead. The melting point of aluminum alloy may be three times as high as babbitt. This provides added protection against localized overheating due to detonation, overloading, misalignment and similar conditions. Material such as copper/lead, however, offers the best combination of strength, surface action, and ability to absorb small particles of debris into the surface of the bearing. Copper/lead can support 12,000 pounds per square inch versus about 7,000 to 8,000 psi for aluminum; it can accommodate less than perfect conditions, and is a more forgiving material than aluminum in a typical application. The material used depends, of course, on the requirements and conditions of use.

Additionally, any or all of tab bearings 122, 124, 126, 222, 310, 410, 510, 610, 710 and 712 may include a bearing housing constructed in either a bimetal or trimetal configuration. A bimetal configuration is constructed of a steel back with a single layer of bearing material, such as babbit, copper-lead or aluminum alloy. A trimetal configuration will have a steel back for support, an intermediate layer of copper-lead or aluminum alloy, and an overlay made of a material such as babbit.

The thrust washer, such as thrust washers 176 of FIG. 2B or full round thrust washer 730, first thrust washer 732 or second thrust washer 734, as seen in FIG. 14, may be constructed of a material similar to that of the tab bearing. Alternatively, the thrust washers may be constructed of a material such as bronze or a solid aluminum alloy.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A bearing comprising:
a body having a first outside edge, a second outside edge opposite said first outside edge, an inner surface, and an outer surface; and
a first tab projecting outwardly from said outer surface at said first outside edge;
wherein said first tab traverses less than half of said first outside edge;
wherein said first tab includes a first surface and a second surface; and
wherein said first tab includes an edge surface, said edge surface projecting outwardly from said outer surface.

2. The bearing according to claim 1, wherein said first tab is disposed approximately at a mid-chord point of said first outside edge.

3. The bearing according to claim 1, including a second tab projecting outwardly from said outer surface and selectively positioned along said first outside edge.

4. The bearing according to claim 3, wherein said first tab is disposed at a first side of said first outside edge, and said second tab is disposed at a generally opposing side of said first outside edge relative to said first side.

5. The bearing according to claim 3, wherein said body further includes a recess formed therein; said recess being adjacent to one of said first tab and said second tab.

6. The bearing according to claim 1, including a second tab projecting outwardly from said outer surface and selectively positioned along said second circumferential edge.

7. The bearing according to claim 6, wherein said first tab and said second tab are generally aligned.

8. The bearing according to claim 6, wherein said first tab is disposed approximately at a mid-chord point of said first outside edge, and said second tab is disposed at approximately a mid-chord point of said second outside edge, said first tab and said second tab being generally aligned.

9. The bearing according to claim 6 , including a third tab and a fourth tab, wherein said third tab projects outwardly from said outer surface at said first outside edge and said fourth tab projects outwardly from said outer surface at said second outside edge.

10. The bearing according to claim 9, wherein said first tab and said fourth tab are generally aligned, and said second tab and said third tab are generally aligned, and wherein said first tab is disposed at a first side of said first outside edge, and said third tab is disposed at a generally opposing side of said first outside edge relative to said first side.

11. The bearing according to claim 2, wherein said first tab is disposed at an angle of approximately ninety degrees relative to said outer surface.

12. The bearing according to claim 2, wherein said inner surface has a single lining.

13. The bearing according to claim 12, wherein said inner surface has an overlay disposed on said lining.

14. The bearing according to claim 2, wherein said inner surface includes an oil bearing groove.

15. The bearing according to claim 2, wherein said tab has a width between about 0.2 inches and about 1.0 inch.

16. A bearing assembly comprising:
an upper bearing insert and a lower bearing insert, wherein both of said upper bearing insert and said lower bearing insert each having a first circumferential edge, a second circumferential edge opposite said first circumferential edge, an inner surface, and an outer surface; and
a first tab selectively borne on and projecting outwardly from said outer surface at a first tab bearing circumferential edge, said first tab bearing circumferential edge being a first circumferential edge of one of said upper bearing insert and said lower bearing insert;
wherein said first tab traverses less than half of said first tab bearing circumferential edge;
wherein said first tab includes a first surface and a second surface; and
wherein said first tab includes an edge surface, said edge surface projecting outwardly from and selectively positioned on said tab bearing circumferential edge.

17. The bearing assembly according to claim 16, wherein said first tab is disposed on said lower bearing insert.

18. The bearing assembly according to claim 16, wherein said first tab is disposed on said upper bearing insert.

19. The bearing assembly according to claim 16, wherein said first tab is disposed at approximately a mid-chord point of said first tab bearing circumferential edge.

20. The bearing according to claim 16, including a second tab projecting outwardly from and selectively positioned on said first tab bearing circumferential edge.

21. The bearing assembly according to claim 20, wherein said first tab and said second tab are disposed on said lower bearing insert.

22. The bearing assembly according to claim 20, wherein said first tab and said second tab are disposed on said upper bearing insert.

23. The bearing assembly according to claim 20, wherein said first tab is disposed at a first side of said first tab bearing circumferential edge, and said second tab is disposed at a generally opposing side of said first tab bearing circumferential edge relative to said first side, and said first tab and said second tab are disposed on said lower bearing insert.

24. The bearing assembly according to claim 20, wherein said first tab is disposed at a first side of said first tab bearing circumferential edge, and said second tab is disposed at a generally opposing side of said first tab bearing circumferential edge relative to said first side, and said first tab and said second tab are disposed on said upper bearing insert.

25. The bearing assembly according to claim 16, wherein said first tab is integrally formed with one of said lower and upper bearing inserts.

26. The bearing assembly according to claim 16, wherein said first tab is welded to one of said lower and upper bearing inserts.
